(19) United States
(12) Patent Application Publication
(10) Pub. No.: US 2013/0159017 A1
(43) Pub. Date: Jun. 20, 2013

(54) METHOD AND SYSTEM FOR VERIFYING A USER'S HEALTHCARE BENEFITS

(71) Applicant: James E. Burkholder, Fair Oaks Ranch, TX (US)

(72) Inventor: James E. Burkholder, Fair Oaks Ranch, TX (US)

(21) Appl. No.: 13/717,575

(22) Filed: Dec. 17, 2012

Related U.S. Application Data
(60) Provisional application No. 61/576,429, filed on Dec. 16, 2011.

(51) Int. Cl. G06F 19/00

(52) U.S. Cl. CPC G06F 19/328
USPC 705/3

(57) ABSTRACT

The present invention provides a method and system by which a service provider is able to verify the benefit eligibility of a patient. Methods and systems of the claimed invention are used to create one or more queries to verify a patient's insurance benefits in a database to determine the eligibility of the claim. Embodiments of the invention are also used to verify a patient's claims history.

### CROSS-REFERENCES TO RELATED APPLICATIONS

This Application claims the benefit under 35 U.S.C. §119(e) of U.S. Provisional Patent Application Ser. No. 61/576,429, filed Dec. 16, 2011, which is incorporated herein by reference in its entirety as if fully set forth herein.

### TECHNICAL FIELD OF THE INVENTION

The invention relates generally to data processing software for inquiring and determining eligibility for reimbursement for patients by comparing the patient information against a benefit provider's database of covered persons to determine if the patient is eligible for benefits and, if so, associating the patient record with the matching record in the benefit provider's database so the service provider can seek to be reimbursed for the services provided to the patient.

### BACKGROUND OF THE INVENTION

The provision of health care services in the United States has become the focus of much attention. With the costs of medical malpractice insurance spiraling, and the payments being made to health care providers from benefit providers, including private and government insurers being reduced continually, health care providers are finding it necessary to get payments for all the services they actually render.

Unfortunately, many health care providers are not receiving compensation for the services they render. This could be due to a number of factors, such as patients not having the ability to pay for the services, and/or not having any medical payment system or insurance. In other instances, medical care service providers submit a request to determine if a patient is eligible for coverage under a private or government insurance plan, but are told the patient is not eligible for coverage. Often, payment for services rendered is denied due to incorrect data entry about a patient and/or the service rendered, through failure to associate the information with the correct patient record in the benefit provider's database, or other misunderstandings or mis-associations.

For medical care service providers, being denied payment for services rendered is problematic, and can, in some cases, mean the difference between profitability and a business that does not show a profit. Typically, such claims which are classified as not eligible for reimbursement are written off as bad debt for which collection cannot be achieved. Ultimately, these costs are either passed along to other patients by means of cost increases, or the care provided is cut back to save or reduce costs.

Accordingly, a continuing search has been directed to the development of methods which can help medical care service providers maximize identification of patients' benefits from either private or government medical insurance so the service providers can be reimbursed for claims.

Therefore, what is needed is a system and/or method for helping to efficiently verify a patients' medical benefits and identify claims for which the patients are eligible for health care benefits, which can be paid to the health care provider.

### SUMMARY OF THE INVENTION

Normally, claims for medical care are submitted to a patient's benefit provider for payment. Prior to submitting the claim, the health care provider will need to make an eligibility inquiry to determine whether the person for whom the service was provided is eligible for benefits; if not, payment to the health care provider will be denied. In many cases, the denial is because the information entered on the claim submitted to the benefit provider by the service provider cannot be correlated with the information in the benefit provider's database because the patient could not be located in the benefit provider's database due to inconsistencies. In some instances, this is due to a data entry error on the part of the service provider, benefit provider, or both. In other instances, the patient may not be eligible for insurance coverage at the time the services are rendered, or when the eligibility verification inquiry is made.

The claimed invention provides a software program that will automatically, upon request, query a central database comprising information derived from benefit providers with a variety of different queries to find persons who are eligible to receive benefits, and who match patients in a service provider's database for whom services have been or may be provided. The software of the present invention will also automatically segregate those records for which there is a match between the databases for further processing, and can indicate the matching information found in the benefit provider's database. For example, the software of the present invention can inquire whether the patient is covered by the benefit plan, whether the services provided are covered by the benefit plan, and/or whether the provider is authorized to provide services for persons covered by that benefit plan. The software of the invention is also capable of determining previous claims filed by or on behalf of a patient, i.e., the patient's claim history.

The software of the present invention also provides means for comparing records in the benefit provider's database against a service provider's claims and finding records that, while not a complete match, have a predefined number of parameters that match, such that upon further analysis and correction, it may be determined that a patient claim is eligible for reimbursement and can be submitted to the benefit provider, and the service provider will be reimbursed for the services performed. The software of the present invention can easily reveal the field or fields in which there is a difference in the information between the service provider's claim and the benefit provider's database, making correction of any claim errors much simpler and making the present invention much more cost-effective than prior art which did not reveal any such partial matches, or show errors that had caused a claim that was submitted to have been rejected, but only verified whether or not there was a complete match.

The software of the present invention can also show whether the patient was qualified to be covered by a benefit plan at the time the services were rendered. In some instances, the patient was not eligible for coverage at the time the initial inquiry was made, but becomes eligible for coverage at a later time, and the coverage is retroactive back to a period including the time at which the service provider rendered treatment. If this retroactive eligibility is discovered and identified in a timely manner, a request for retroactive reimbursement can be made in some cases.

In other cases, even if the eligibility qualification is not discovered in time to seek reimbursement, the un-reimbursed claims can be important for a health care service provider in determining if it is entitled to reimbursement under various government programs for treating uninsured persons, and to help the service provider keep accurate track of how much of such funding they might be entitled to.

The present invention can also be used to generate reports in a variety of configurations, as to record matches found, to assist in identifying errors, determining sources of errors, and taking steps to prevent similar future errors. A surprising number of matches between service provider claims and benefit provider databases of persons eligible for reimbursement were found using the software of the present invention that were not found using prior art software. Even when the software of the present invention is used to query the same benefit provider's database for the same health care provider's claims, matches are found that were not found when the same or similar queries were previously made.

The foregoing has broadly outlined the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

FIG. 1 shows a high level flow diagram of the web portal network in accordance with an embodiment of the invention.

### DETAILED DESCRIPTION OF EXEMPLARY EMBODIMENTS

Normally, claims for medical care are paid for by a patient directly, or submitted to a patient's benefit provider for payment, such as a private health insurance company, or government-subsidized health care insurance, such as Medicare, Medicaid or other government-funded programs. After processing to verify such things as whether the person for whom the service was provided is covered by the benefit provider, whether the services provided are covered by the benefit plan, whether the services were rendered during a period the patient was covered by the benefit provider, and whether the service provider is authorized to provide services for persons covered by that benefit plan, the benefit provider will pay the health care service provider for the service provided at a specified rate. However, typically, the service provider is required to contact the benefit provider for each patient separately to determine the benefits and the eligibility of the patient to receive the requested care.

Additionally, there may be instances wherein, a service provider does not have the time to contact a particular benefit provider by phone or other means before the service is rendered. In such cases, the service provider may find out after the service has been provided that the patient does not have the requisite insurance benefits. Thus, it would be useful to have a convenient system that allows a service provider to ascertain the benefits of a patient without having to directly contact the patient's benefits provider.

Denial of eligibility for treatment is typically because the service provider is not authorized to provide service for persons covered by a specific benefit plan, the service provided is not covered by the benefit plan of the patient, the date on which the service was provided was not a covered date, or the patient is not covered by the benefit plan. In many cases, the denial is because the information entered on the claim submitted to the benefit provider by the service provider cannot be correlated with the information in the benefit provider's database, and therefore the claim is returned as ineligible. In reality, in many of these situations, the patient/service/date/service provider are eligible claims within the scope of the benefit plan, but there is a mistake or difference in the information on the claim and the information in the benefit provider's database, and so the claim is not considered eligible for reimbursement.

Additionally, while in many cases, a claim must be submitted within a certain time period after service is rendered, if the person becomes eligible retroactively, but after the allowed time period for filing claims, a request can be made for payment for services that were rendered that would be covered by the benefit plan. Thus, it is important to make inquiries as to eligibility status at frequent intervals to determine if a person is eligible while still within the time period during which a request for payment can be made.

Under certain new laws and regulations, such as the Health Insurance Privacy and Portability Act (HIPPA), which regulates the insurance benefit industry, service providers are authorized to access the benefit providers' databases, or to enable other parties to authorize the benefit providers' databases on their behalf to make inquiries as to patient eligibility status. In some instances, if certain specifications are met as to the software used and other requirements, the benefit provider must make the information in their database available for such inquiries without charge. As an example, the software of the present invention is fully compliant with the new laws and regulations.

An embodiment of the invention is directed to a method employed with a data processing system for determining eligibility of medical claims, the method comprising: a) creating a file of claims for a health care service provider, the file containing at least one field for each claim; b) accessing a database of patient records for a benefit provider; c) comparing at least a portion of at least one field for at least one claim in the file of claims to at least a portion of at least one associated field in at least one patient record in the database of patient records for the benefit provider; d) if the compared fields match, placing the matched claim and the information from the field of the matching patient record in a file of matching records; and e) removing the matched claim from the file of claims.

In accordance with an embodiment of the invention, a computer program product is provided for determining eligibility of medical care claims having a medium with a computer program embodied thereon, the computer program comprising: a) computer code for finding records in a benefit provider's database that correspond at least in part to one or more fields of information on a claim for a service provider; b) computer code for separating out the claims for which there is a matching record; c) computer code for generating a file containing all claims with matching records for further processing; and d) computer code for submitting the further processed eligible claims to the benefit provider.

A further embodiment of the invention is directed to a computerized data processing system for analyzing medical care claims to determine claim eligibility status comprising: a) creating a file of a service provider's claims in a machine-readable format; b) preparing one or more queries to find records in at least one benefit provider's database that match, at least in part, one or more claims in the file of the service provider's claims; c) executing a first query for the first claim in the file of claims; d) when the query finds the record in the benefit provider's database that matches the claim, obtaining the information contained in the matching record; e) associating the information from the record with the matching claim; f) inserting the matched claim and the information from the matched record from the benefit provider's database in a second file; g) removing the matched claim from the file of the service provider's claims; h) repeating steps c through g for each subsequent claim in the file of the service provider's claims; i) determining if there are any additional queries to be performed and, if so, for each additional query, executing steps c through h; and j) creating a report of the information in the second file.

An embodiment of the invention provides a platform for healthcare providers to gain access to a centralized database for health plan coverage information, member/patient data, and payer (i.e., insurance company) sources. The embodiment provides an innovative approach for connecting the key parties involved in a healthcare transaction by using a single secure online portal.

Another embodiment of the invention provides a payer such as an insurance company the ability to access the online portal containing patient and medical services provider information.

In an embodiment of the invention, a patient is required to go through a one-time initial registration at the online portal, which will collect the information needed to ensure the portal is secure and HIPPA compliant. Traditionally, providers are required to go through a manual process of calling customer service for each individual health plan/payer. With the claimed invention, providers now have access to data for verifying member's/patient's benefits, reviewing claims, and other patient medical information, from within the secure online portal. Similarly, insurance companies can utilize the data on the online portal to verify a user's benefits and the number of insurance companies that a user is receiving benefits from. Typically, this information is required to be provided by the user. However, the claimed invention makes it possible for insurance companies to obtain information about a user's coverage without having to rely on the user for the information.

Upon login, the online portal displays dashboard tools allowing users to gain an overview of their account and the user connected network. Furthermore, users are able to easily navigate the system to drill deeper into areas of the portal to access data and/or providers, payers, and patients connected to their profile account.

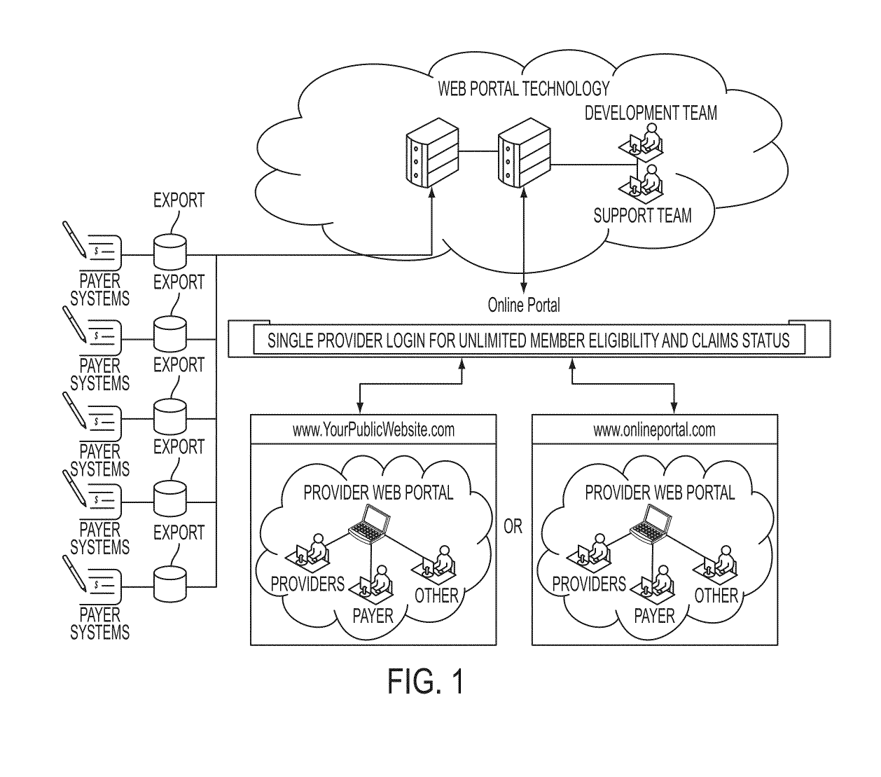

As set forth in FIG. 1, the web portal allows users to have a single username and password to access all the connected payer data. In certain embodiments of the invention the login is located at the Payer site, i.e., the insurance company site. In alternate embodiments of the invention, the user can login to a website that is specifically created for accessing the web portal, e.g., www.onlineportal.com in FIG. 1.

Upon logging in, the user is connected to a database that contains information relating to an individual's insurance benefits, the names of the providers as well as the individuals covered under a specific plan. The user will be able to view data from all payer systems located in the data warehouse.

In certain embodiments of the invention, the user is an individual who has health insurance and wants to check their insurance coverage and status. In another embodiment of the invention, the user is a medical service provider such as a hospital or doctor's office that wishes to know the current status of a patient's health care/insurance benefits. In a further embodiment of the invention, the user is a payer or benefit provider such as an insurance company or employer that wishes to know the current status of an individual's insurance as well as all of the plans that the individual is covered by.

After logging into the online portal, the user initiates a search. In certain embodiments of the invention, the search is directed to finding the claims filed by a person that has utilized medical services, such as a patient. In certain embodiments of the invention, a medical service provider initiates a search on the online portal in order to determine a patient user's benefits and payers providing these benefits. The online portal site is updated automatically when a match is found between a user account and an insurance company (payer).

In certain embodiments of the invention, the payer is able to view the same information as a provider when pulling up a user's eligibility and benefits.

It is understood that the present invention can take many forms and embodiments. Accordingly, several variations may be made in the foregoing without departing from the spirit or the scope of the invention. Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

What is claimed is:

1. A method employed with a data processing system for determining eligibility of unpaid medical claims, the method comprising: a) creating a file of claims for a health care service provider, the file containing at least one field for each claim; b) accessing a database of patient records for a benefit provider; c) comparing at least a portion of at least one field for at least one claim in the file of claims to at least a portion of at least one associated field in at least one patient record in the database of patient records for the benefit provider; d) if the compared fields match, placing the matched claim and the information from the field of the matching patient record in a file of matching records; and e) removing the matched claim from the file of claims.

2. The method of claim 1 further comprising comparing the at least one portion of the at least one field of at least a second claim to at least one portion of at least one associated field in at least one patient record in the database of patient records for the benefit provider, and if the compared fields match, placing the at least a second claim and the information from the field of the matching patient record in a file of matching records, and removing the matched claim from the file of claims.

3. The method of claim 1 further comprising generating a report from the file of matching records including claim information and the information from the matching patient record.

4. A computer program product for determining eligibility of medical care claims having a medium with a computer program embodied thereon, the computer program comprising: a) computer code for finding records in a benefit provider's database that correspond at least in part to one or more fields of information on a claim for a service provider; b) computer code for separating out the claims for which there is a matching record; c) computer code for generating a file containing all claims with matching records for further processing; and d) computer code for submitting the further processed eligible claims to the benefit provider.

5. The computer program of claim 4 further comprising computer code for performing analysis on claims having matching records to evaluate the probability that the record in the benefit provider's database is for a same person as the service provider's claim.

6. A computerized data processing system for analyzing medical care claims to determine claim eligibility status comprising: a) creating a file of a service provider's claims in a machine-readable format; b) preparing one or more queries to find records in at least one benefit provider's database that match, at least in part, one or more claims in the file of the service provider's claims; c) executing a first query for the first claim in the file of claims; d) when the query finds the record in the benefit provider's database that matches the claim, obtaining the information contained in the matching record; e) associating the information from the record with the matching claim; f) inserting the matched claim and the information from the matched record from the benefit provider's database in a second file; g) removing the matched claim from the file of the service provider's claims; h) repeating steps c through g for each subsequent claim in the file of the service provider's claims; i) determining if there are any additional queries to be performed and, if so, for each additional query, executing steps c through h; and j) creating a report of the information in the second file.

7. The system of claim 6 further comprising querying the file of matched claims and associated information from the benefit provider's database to determine if the date the service was provided is within the scope of the date for which the patient was covered by the benefit provider.

8. The system of claim 6 further comprising submitting the information from the report to the benefit provider for payment of the claims contained therein.

9. The system of claim 6 further comprising using the report to create claim forms for submission to the benefit provider for payment.

10. The system of claim 6 further comprising determining if the matching record for a claim is for a same person as the service provider's claim.
